(19) United States
(12) Patent Application Publication
(10) Pub. No.: US 2003/0080847 A1
(43) Pub. Date: May 1, 2003

(54) Low voltage, high current power transformer

(76) Inventor: James G. Radzelovage, Londonderry, NH (US)

Correspondence Address: Michael G. Savage, BURNS, DOANE, SWECKER & MATHIS, L.L.P., P.O. Box 1404, Alexandria, VA, 22313-1404, US

(21) Appl. No.: 10/032,525

(22) Filed: Oct. 27, 2001

(51) Int. Cl. H01F 27/28

(52) U.S. Cl. 336/229

(57) ABSTRACT

A power toroid transformer is provided. A plurality of conductors are equally spaced around the magnetic core. Each conductor partially encloses a portion of the core and is adapted to be electrically connected to form a winding. A single sheet of metallic material is formed to partially enclose at least portions of the core. The edges of the sheet are adapted to be electrically connected to form a winding.

### BACKGROUND

This invention generally relates to transformer design. More particularly, the present invention provides a low voltage, high current power transformer.

Low voltage, high current power sources are in increasing demand for powering the latest generation of gigahertz-plus microprocessor-controlled products. Market forces demand that products using these microprocessors be as small as possible, which creates difficult thermal management problems for the product engineer.

Toroid core transformers, and methods of constructing transformers having toroid cores, have been known for many years. A toroid transformer is traditionally made by placing windings around a core having a toroid shape. Such windings require the conductor to be wound through the center “hole” of the toroid core. One typical arrangement is to have the primary wound on one-half the toroid and the secondary (or other windings) wound on the remaining half.

Another typical arrangement has the primary, secondary, and possibly additional windings, wound in layers. For example, the primary winding may be a first layer and a secondary winding may be a second layer. Thicknesses of insulation are provided between windings to provide a dielectric between the various windings. The insulation is often layers of film which are wound through the center “hole” of the toroid core.

One advantage of toroid construction, relative to other physical constructions, is a reduction of material volume needed for the core for a given electrical capacity. This reduces the weight and cost of the transformer. However, the equipment required to wind long conductor lengths on a toroid core is costly and complex. Additionally, the winding of the conductor and insulating films through the center hole of the toroidal core is labor intensive, thus increasing the cost of making the winding.

One type of toroidal transformer winding is called progressive winding. A progressive winding is one in which the coil is wound such that portions of a total winding are wound in a number of wedge-shaped segments around the toroid. Each wedge-shaped segment typically includes an odd number of layers, with each layer being pitched in the opposite direction to the preceding layer. After the desired odd number of layers of one segment have been completed, the other wedge-shaped segments of the toroid are wound, again by layers. This is repeated until the winding is complete. Progressive winding reduces the maximum turn-to-turn voltage gradient or stress on the conductor insulation.

Toroidal transformers may be used to meet the needs of a variety of applications, especially those that require low profiles. However, traditional toroidal winding methods introduce performance penalties when the transformer design dictates that a winding present a low output voltage, with a correspondingly low turns count. Generally, toroidal transformers provide the best performance when all of the windings (or, more specifically, the current flow within the windings) are evenly distributed around the core. But when the required turns count gets very low, traditional wires and winding methods make it impossible to keep the current distribution uniform. This is because consecutive turns of the winding must be steeply spiraled around the core, leaving significant spaces between turns. This effect becomes most pronounced when the turns count is reduced to one, where current flow is restricted to a narrow channel at some arbitrary point on the toroid, while all other points within the same layer carry no current at all. Although this effect can be mitigated somewhat by breaking the single winding into multiple paralleled windings, this practice increases the complexity, and often the cost, of the design.

Accordingly, there is a need to provide a low voltage, high current power transformer suitable for low profile applications.

### SUMMARY

A cost-effective transformer well-suited for high frequency switching power supply circuits required to convert conventional d.c. power sources (12V, 48V, etc.) down to very low voltage levels (typically less than 6 Vdc) at high current (perhaps 100 Amps) is provided. The transformer is also well suited to meet low profile packaging requirements because the toroidal core upon which the transformer design is based is relatively easy to fabricate with low height-to-diameter aspect ratios, and because the high current conductors can be relatively thin.

In accordance with one aspect of the present invention, a power transformer has a magnetic core with a toroid shape. A plurality of conductors are equally spaced around the magnetic core. Each conductor partially encloses a portion of the core and is adapted to be electrically connected to form a winding. A single sheet of metallic material is formed to partially enclose portions of the core. The edges of the sheet are adapted to be electrically connected to form a winding.

In accordance with another aspect of the invention, a power transformer has a magnetic core with a toroid shape. A plurality of conductors are equally spaced around the magnetic core, with each conductor partially enclosing a portion of the core. The conductors are adapted to be electrically connected to form a winding. A single sheet of metallic material is formed to enclose the core. The edges of the sheet are adapted to be electrically connected to form a winding.

In accordance with yet another aspect of the invention, a transformer includes a magnetic core and a plurality of conductors. Each conductor partially encloses a portion of the core and is adapted to be electrically connected to form at least a first and second winding. At least some of the conductors may be substantially U-shaped, and the magnetic core may be toroid in shape.

In accordance with still another aspect of the invention, a printed circuit assembly includes a printed circuit board having a plurality of conductive traces and a transformer electrically connected to the printed circuit board. The transformer has a magnetic core and a plurality of conductors. Each conductor partially encloses a portion of the core and is adapted to be electrically connected. At least some of the plurality of conductors are electrically connected in series with at least some of the conductive traces to form a first winding and at least some of the plurality of conductors are electrically connected in series to at least some of the conductive traces to form a second winding, the second winding being separate from the first winding.

It should be emphasized that the term “comprises” or “comprising,” when used in this specification, is taken to specify the presence of stated features, integers, steps, or components, but does not preclude the presence or addition of one or more other features, integers, steps, components, or groups thereof.

### BRIEF DESCRIPTION OF DRAWINGS

The objects and advantages of the invention will be understood by reading the following detailed description in conjunction with the drawings in which:

FIG. 1a is a side view of an embodiment of a transformer in accordance with the invention;

FIG. 1b is a bottom view of the transformer in FIG. 1a;

FIG. 2a is a side view of another embodiment of a transformer in accordance with the invention;

FIG. 2b is a bottom view of the transformer in FIG. 2a;

FIG. 3 is a schematic diagram of a transformer in accordance with the invention;

FIG. 4 is a graph of core loss, copper loss, and total loss plotted as power dissipation as a function of the ratio of the core inner diameter to the core outer diameter; and

FIG. 5 is a graph of effective series resistance as a function of frequency.

### DETAILED DESCRIPTION

The present invention provides a transformer design that maintains a more uniform distribution of winding current around a toroid core than is possible using traditional methods, especially as the turns count of a winding is reduced to one.

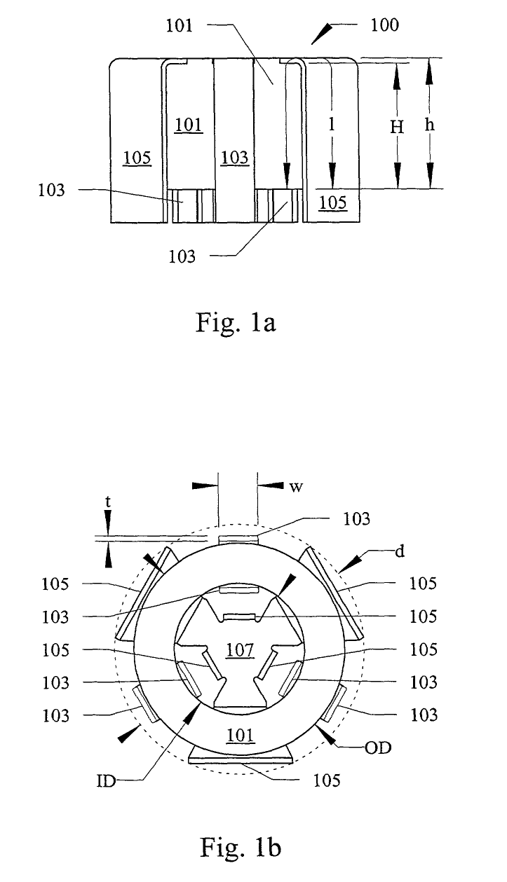

A transformer 100 in accordance with the invention is shown in FIGS. 1a and 1b. FIG. 1b is a bottom view of the transformer 100 in FIG. 1a. The transformer 100 is assembled around a magnetic core 101. The magnetic core may be made of ferrite. In other applications, laminated steel, iron powder, or other magnetizable material may be appropriate. The core has a substantially toroidal shape, but will function with any suitable geometry having a closed contour. As discussed later in this disclosure, the dimensions of the core may be selected such that the voltage and current requirements of the secondary can be met at the prescribed switching frequency using a single-turn winding.

Enclosing the core cross-section are electrical conductors 103, 105 that act as either primary or secondary windings. The conductors 103, 105 may be formed from copper and may be plated with a solderable alloy. The primary may include a plurality of conductors 103 distributed uniformly around the core's annulus. In the embodiment shown in FIG. 1a, thick U-shaped copper staples are used, though these could be replaced by enameled wire, Litz wire, or any traditional winding material as dictated by the application. The secondary may be cut and formed from a single sheet 107 of plated copper, although other suitable metals may be used. The sheet 107 encloses at least portions of the core cross-section and features selectively placed tabs 105 at both the inside and outside faces of the core suitable for use as terminations for printed circuit board mounting. As can be appreciated, it may be is advantageous to minimize the clearance between the secondary tabs 105 and the primary conductors 103, and between the secondary tabs 105 and the core 101. It may also be advantageous to distribute both the primary conductors 103 and the secondary tabs 105 uniformly around the core annulus, thereby achieving a uniform distribution of current in the both the primary and secondary. As shown in FIGS. 1a and 1b, where three primary turns 103 are represented, a natural choice for the shape and positions of the secondary tabs 105 is to locate each of three secondary tabs 105 spaced at 120-degree (i.e., 360 degrees divided by three) intervals around the core annulus, while the three primaries 103 are also spaced at 120-degree intervals around the core annulus, interleaved between the secondary tabs 105. Though both of the embodiments shown are well suited for through-hole insertion into a printed circuit board, the tabs 103, 105, and 205 could also be formed substantially parallel and coplanar to the mounting plane, thereby providing a surface-mounted transformer.

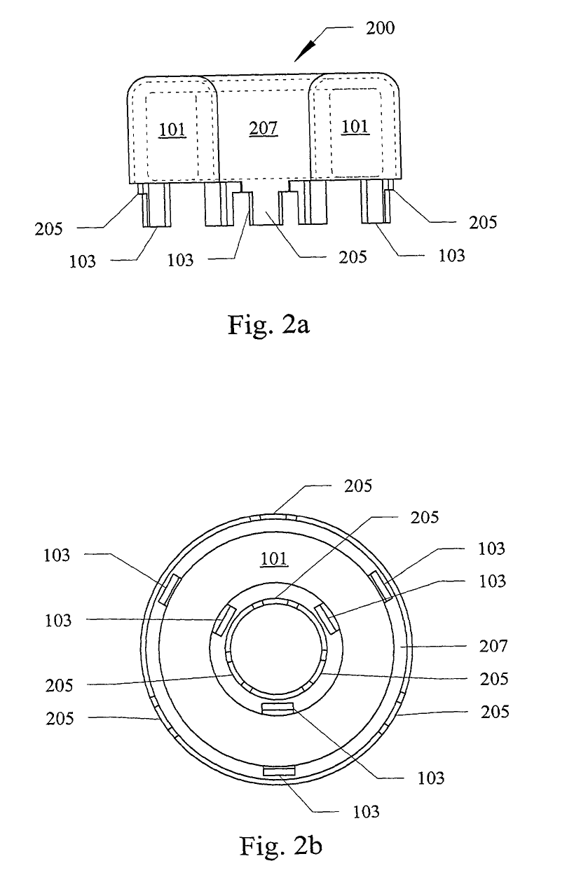

FIGS. 2a and 2b depict an alternate embodiment of a transformer 200. FIG. 2b is a bottom view of the transformer 200 in FIG. 2a. In this embodiment, the transformer structure may utilize a drawn can 207, similar in shape to a Bundt® pan, which would enclose both the core 101 and the primary 103 at all points around their inside and outside perimeters. The radial symmetry of the drawn can 207 provides uniform secondary current distribution. The structure of the drawn can 207 may be especially advantageous when the number of primary turns supported by the core is too large for the interleaving of a tabbed secondary structure 105 to be practical. Tabs 205 are selectively located around the rim of the can 207 and may be used to solder the can 207 to a printed circuit board.

In either transformer 100, 200, positioning the primary and secondary conductors away from each other provides working isolation, even if both are in direct contact with the core, at least to the extent that the resistivity of the core can be tolerated. Where additional isolation is required, one or more of the transformer's component parts can be coated or otherwise protected with insulating material.

Individual conductors contained within the transformer can be secured to the core with any of a variety of suitable adhesives, such as United Resin's Circuit Bond™ adhesive. However, an alternate assembly method can avoid the use of adhesives by modifying the geometry of either the core, the conductors, or both so that all of the components are held together solely by mechanical force.

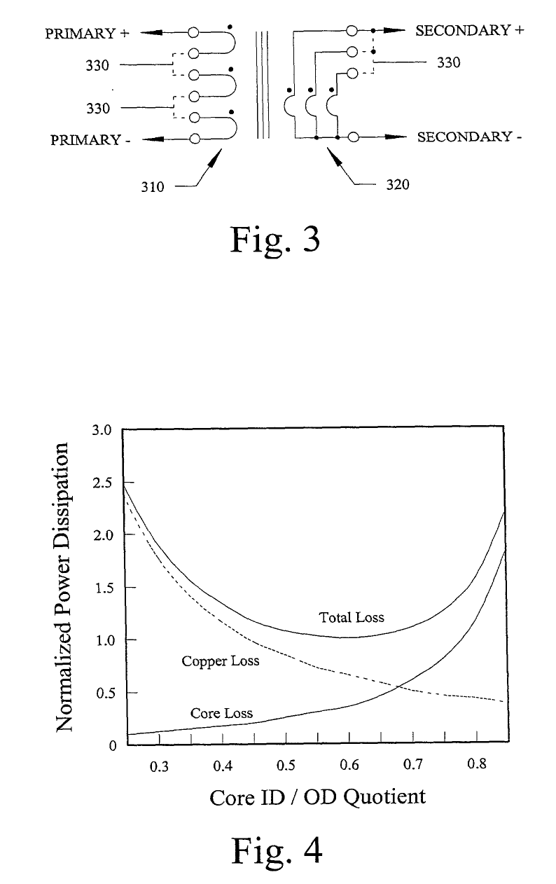

Full functionality of the transformer is realized when the primary and secondary conductors are connected in series, parallel, or any combination thereof by traces on a printed circuit board onto which the transformer is mounted. One configuration includes a series primary winding 310, a parallel secondary winding 320, and printed circuit board interconnections 330, shown schematically in FIG. 3. The dashed lines indicate printed circuit board interconnections 330. As previously noted, conductors 103 form the primary winding 310, and may be connected with the inner tab of one conductor 103 attached via the printed circuit board to the outer tab of another conductor 103. For the secondary winding 320, the tabs 105 on the outside of the core 101 form the node labeled “SECONDARY −” in FIG. 3. The tabs 105 on the inside of the core 101 may be connected in parallel to form the “SECONDARY +” node. As can be appreciated, the number of tabs 105 needing printed circuit board interconnections 330 depends on the number of places that the secondary is interleaved with the primary. In the case of the transformer 200 shown in FIGS. 2a and 2b, the number of tabs 205 needing printed circuit board interconnections 330, and the sizes thereof, depends on the amount of current that the secondary needs to supply.

As previously noted, the dimensions of the core are selected such that the voltage and current requirements of the secondary can be met at the prescribed switching frequency using a single-turn winding. High frequency transformer designs for real-world applications generally result from many compromises between interrelated variables such as size, efficiency, and cost. A mathematically explicit general solution yielding an optimized design exists only when the majority of these variables are dictated a priori, and even then the derivation of such an equation is often a needlessly rigorous endeavor. Fortunately, transformer performance is generally insensitive to minor variations in geometry. In fact, insensitivity to minor variations is a de facto requirement for mass produced designs since some degree of variability in materials is inevitable. This is especially true with regard to the magnetic properties of core materials. Lacking an explicit solution, one alternative approach is to design using successive iterations guided by trial-and-error. Although this may not yield a theoretically optimum design, it is often possible within a small number of iterations to derive a solution that falls well within the inherent tolerances expected in the characteristics of the materials used.

While it is possible for any combination of physical or practical considerations to constrain a design, the most common of these are size and cost. Generally, the smallest component will have the lowest cost, but will also have the lowest efficiency. Excessive inefficiency leads to excessive power dissipation, the temperature rise from which ultimately puts a lower limit on the size of any design solution. The fundamental design compromise, then, is usually between size and power dissipation.

Power dissipation within the transformer results from hysteresis and eddy current losses caused by alternating flux within the magnetic core (commonly referred to as “core loss”), and by Ohmic losses caused by current flow within the windings (commonly referred to as “copper loss”). If an initial target size for the transformer can be selected, it is possible to estimate the upper limit of allowable power dissipation. Given the thermal constraints of maximum ambient temperature T_{amb} (° C.), and maximum operating temperature Tₘₐₓ (° C.), the allowable power dissipation P_{D(Limit)} (mW) can be estimated at

P_{D(Limit)}≈π·(1.5·d·h+d²/4)·(Tₘₐₓ−T_{amb})^{1.2} [Eq. 1]

where d is the basic diameter and h is the height of the transformer (both in cm). This estimate assumes that the finished transformer has a geometry similar to that of FIG. 1a or FIG. 2a, and that cooling is by natural convection. For reference, FIGS. 1a and 1b include dimensions labels d, l, H, h, w, t, ID, OD. It should be recognized that the dimensions apply to comparable structures in FIGS. 2a and 2b as well. Dimension h, as shown in FIG. 1a, excludes the portion of the tabs that would normally be inserted into printed circuit board vias under the assumption that heat generated at the interconnection interfaces will be dissipated primarily by features external to the transformer, such as a printed circuit board. P_{D(Limit)} may be enhanced if provisions are made for forced convection, or if additional cooling is accomplished by conductive or radiant means.

Once the total allowable power dissipation is established, a portion of the allowable power dissipation is allocated to core loss and the remainder of the allowable power dissipation is allocated to copper loss. It is common practice when designing high frequency transformers to allocate these losses equally. This practice is based on the assumption that, for a transformer of fixed volume, incremental changes around the optimum operating point result in the trading of core loss for copper loss on a unit-for-unit basis. In contrast, the geometry described herein demonstrates the behavior shown in FIG. 4. Given target dimensions for both the core outside diameter (OD) and height (H), the core and copper loss components as a function of the core inside-outside diameter (ID/OD) quotient for a typical geometry can be plotted. For most practical core materials and winding geometries, the magnitude of the core loss slope will exceed that of the copper loss slope at their point of intersection. Consequently, the total loss curve achieves a minimum (indicating optimum efficiency) at a point that favors excess copper loss. Accordingly, the first design iteration targets the portion of P_{D(Limit)} allocated to core loss at 35% and copper loss at 65%. If this condition requires that the core material operate near or beyond its flux saturation limit, the core loss allocation must be reduced accordingly. However, since most power supply applications utilize switching frequencies near or above 100 KHz, practical magnetic cores are likely to be constrained by their loss characteristics rather than by flux saturation.

In designing a structure similar to that shown in FIG. 1, practical mechanical considerations dictate that the dimensions of the toroidal core be chosen as approximately

OD=0.8·d [Eq. 2]

and

H=0.95·h. [Eq. 3]

Of course, it will be appreciated that other dimensions can be used as appropriate. Curves from FIG. 4 suggest that the core ID be chosen initially as

ID=0.6·OD [Eq. 4]

From these dimensions, the effective core area Aₑ is given by

Aₑ=H·(OD−ID)/2 [Eq. 5]

while the effective core volume Vₑ is approximated by

Vₑ≈H·π(OD²−ID)/4. [Eq. 6]

Given that at least one of the windings on the transformer will be formed by only a single turn, it is preferable that this winding be the one required to support the lowest working voltage, with the highest working current at that voltage. (This winding is referred to as the “main secondary” regardless of its actual function within the circuit.) Assuming that the main secondary voltage waveform is substantially a square pulse of amplitude V (Volts) and duty cycle DC, the magnetic flux density Bₘₐₓ (Gauss) within the core is then given by

Bₘₐₓ=10⁸·V·DC/(2·f·Aₑ) [Eq 7]

where f is the fundamental switching frequency (Hz) and DC equal to 50% (0.5) represents a fully symmetric square wave. The resulting core loss density can then be calculated using the manufacturer's specifications for the selected material. Most switching power supply applications are optimized using power ferrite, the loss densities of which can be described with reasonable accuracy by an equation of the form

ρ^{Fe}αBₘₐₓ^{a}·f^{b} [Eq. 8]

where ρ_{Fe} is the power loss density of ferrite, and a and b are constants, typically around 2.5 and 1.5, respectively. The core loss can then be calculated by

P_{Fe}=Vₑ·ρ_{Fe}. [Eq. 9]

If the resulting power loss is significantly different from the target value of 0.35·P_{D(Limit)}, one or more core dimensions can be varied and P_{Fe} recalculated. The process can be repeated until the target value is approximated within any desired accuracy.

Once the core geometry is selected, the structure of the windings can be tentatively determined. Given that the main secondary consists of a single turn, the turns count(s) of any other winding(s) on the transformer will be dictated by the input and/or rectification topologies used in the associated drive circuitry. An analysis of such circuitry is well treated in A. I. Pressman, Switching Power Supply Design, 2nd edition (1998, McGraw-Hill). For a structure similar to that shown in FIG. 1, the individual primary turns and the tabs of the single-turn main secondary are interleaved evenly around the core annulus. The widths of the conductors are chosen such that the clearance between primary turns and main secondary tabs, and between the windings and core, is kept as small as practical considerations permit, thus minimizing leakage impedance.

Once the conductor widths are selected, the conductor thicknesses can be determined. Given that most high frequency transformer designs are subject to skin effects, there is a point of diminishing return pertaining to the thickness of the conductors. The relevant parameter, skin depth, is defined as the distance below a conductor's surface at which the current density is reduced to 1/e (≈36.8%) of the surface density. For copper conductors operating at 70° C., the skin depth Δ (mm) is given by

Δ=72.1/√f. [Eq. 10]

Ampere's law dictates that current flow will be substantially constrained to a region flush with the outermost edges of the conductors and penetrating to depth Δ. There is generally little to be gained in efficiency once the conductor thickness exceeds about two skin depths, so this is a good initial choice for conductor thickness t (mm):

t=2·Δ. [Eq. 11]

In the case where the transformer has exactly one N-turn series-connected primary and one main secondary winding, both of which are active simultaneously, it is generally a good choice to assign the thickness given by Eq. 11 to all of the conductors. Deviations from this rule may be appropriate, however, if the currents in the windings are not present simultaneously, as in a flyback topology, or if the thickness must be varied for thermal or mechanical considerations.

With the conductor dimensions thus selected, it is possible to estimate the full-load copper loss of the transformer. For transformers used in forward converter topologies, the copper loss P_{Cu} (Watts) can be approximated as

P_{Cu}≈ESR·Iₚᵣᵢ² [Eq. 12]

where ESR is the Effective Series Resistance (Ω) and Iₚᵣᵢ is the expected full-load primary current (A_{RMS}). The ESR term refers to the real component of leakage impedance as reflected to the primary and is given by

ESR=Rₚᵣᵢ+N²·R_{sec} [Eq. 13]

where Rₚᵣᵢ is the primary winding d.c. resistance (Ω), N is the primary turns count, and R_{sec} is the main secondary winding d.c. resistance (Ω). Rₚᵣᵢ will be the series sum of the N individual primary turns, while R_{sec} will be the parallel sum of the resistances of the tabs of the main secondary. For accuracy, the resistances should be corrected to the highest allowable operating temperature Tₘₐₓ.

The target value for copper loss resulting from Eq. 12 is typically 20% of the copper loss allocation. This apparent overdesign is advantageous because the actual winding resistance is very frequency-dependent due to skin effects and is always higher than the d.c. values used in Eq. 12. Also, because the primary current value (Iₚᵣᵢ) used in Eq. 12 typically represents a substantially square current pulse, the current waveform will contain frequency components that will induce losses at multiples of the fundamental switching frequency, where skin effects will be even more severe. For a conductor thickness t, chosen as suggested in Eq. 11, the aggregate effect of these loss components multiplies the value calculated by Eq. 12 by roughly a factor of 5. Thus, the overdesign actually places the expected copper loss at the target value.

If a detailed analysis of the expected copper loss indicates that it will vary significantly from the allocated target value, a recalculation of the copper losses using favorable adjustments in the winding thickness can be done. This is likely to occur, for example, if the conductor thickness t is chosen to be substantially less than the value suggested by Eq. 11, since skin effects will be less pronounced at the fundamental and lower harmonics of the switching frequency.

The transformer 100, 200 may be used in a forward converter-type d.c.-d.c. switching power supply having the performance shown in Table 1.

TABLE 1

| | 12 V nominal square wave, |
|---|---|
| | 50% maximum |
| Input signal (Vₚᵣᵢ) | pulse duty cycle (DC) |
| Drive circuit topology | H-bridge |
| Switching frequency | 200 KHz nominal |
| Output voltage | 1.4 V_{d.c.} |
| Output current | 55 A_{d.c.} |
| Output topology | full-wave rectification |
| | with current doubling |
| Target diameter | 1.0 inches (2.54 cm) |
| Height limit | 0.5 inches (1.27 cm) |
| Maximum operating | 105° C. |
| temperature | |
| Maximum ambient | 65° C. |
| temperature | |

The allowable power dissipation limit is calculated from Eq. 1 to be

$$\begin{matrix}{P}_{D ( Limit )} \approx π \cdot ( 1.5 \cdot d \cdot h + {d}^{2} / 4 ) \cdot {( {T}_{max} - {T}_{a m b} )}^{1.2} \\ \approx π \cdot ( 1.5 \cdot 2.54 \cdot 1.27 + {2.54}^{2} / 4 ) \cdot {( 105 - 65 )}^{1.2} \\ \approx 1696 mW ,\end{matrix}$$

of which 35%, or 594 mW, is initially allocated to core loss.

The core outside diameter is calculated from Eq. 2 to be

OD=0.8·d=0.8·2.54=2.03 cm.

The height is calculated from Eq. 3 to be

H≈0.95·h=0.95·1.27=1.21 cm.

The ID is calculated from Eq. 4 to be

ID≈0.6·OD=0.6·2.03=1.22 cm.

The effective core area is then calculated from Eq. 5 to be

Aₑ=H·(OD−ID)/2=1.21·(2.03−1.22)/2=0.490 cm².

The effective core volume is calculated from Eq. 6 to be

Vₑ=H·π·(OD²−ID²)/4=1.21·π·(2.03²−1.22²)/4=2.50 cm³.

A current-doubling full-wave rectifier circuit that follows the transformer can provide the required 55 A_{d.c.} output current while requiring only one half of this current, or 27.5 A_{RMS}, from the transformer main secondary. However, to do so the rectifier circuit must be provided with twice the required d.c. output voltage plus sufficient voltage to overcome diode forward voltage drops and filter inductor resistance. In this case, the transformer must provide up to 4.0 V_{RMS} square wave across its main secondary. By assigning this winding to be the single-turn main secondary, the core flux density is then determined by Eq. 7 to be

$$\begin{matrix}{B}_{max} = {10}^{8} \cdot V \cdot D C / ( 2 \cdot f \cdot {A}_{e} ) \\ = {10}^{8} \cdot 4.0 \cdot 0.5 / ( 2 \cdot 2 \cdot {10}^{5} \cdot 0.490 ) = 1020 G a u s s .\end{matrix}$$

An analysis of published data for 3F3 material, a soft ferrite supplied by Philips Electronics, yields a family of core loss density curves closely approximated by

ρ_{Fe}=3.82·10⁻¹⁶·Bₘₐₓ^{2.43}·f^{1.96},

where ρ_{Fe} is in mW/cm³. Under the conditions currently proposed, the expected core loss density can then be calculated as

ρ_{Fe}=3.82·10⁻¹⁶·1020^{2.43}·(2·10⁵)^{1.96}=192 mW/cm³,

and the total core loss, as determined by Eq. 9, is then calculated to be

P_{Fe}=Vₑ·ρ_{Fe}=2.50·192=480 mW.

This expected loss is reasonably close to, but also comfortably under, the target value of 594 mW.

Using basic transformer theory, it is possible at this point to assign the turns count of the primary winding to be

N=Vₚᵣᵢ/V_{sec}=12.0/4.0=3.

It is advantageous for these primary turns to be realized as copper staples having a uniform width of 3.8 mm. The main secondary can be realized as a formed copper stamping that encloses as much of the core as is practical while providing reasonable clearance to the primary staples. Though the width of the main secondary tabs is not uniform, an analysis of their geometry shows that, for the purposes of calculating resistance, they behave as though they had a uniform width w=6.9 mm.

At the given operating frequency, the skin depth of copper is calculated from Eq. 10 to be

Δ=72.1/√f=72.1/√2·10⁵=0.161 mm.

The thickness of the windings is then suggested by Eq. 11 to be

t=2·Δ=2·0.161=0.322 mm.

Although this thickness would be acceptable from an electrical perspective, more rigid material having a standard thickness of 0.5 mm could be used.

In order to determine the copper losses, it is necessary to determine the winding resistances. In general, the d.c. resistance (D) at 20° C. along the length of a uniform copper conductor having length l, width w, and thickness t is given by

R_{DC}=1.724·10⁻⁵l/(w·t), [Eq. 14]

where l, w, and t are all in millimeters (mm). Further analysis of the tentative winding geometry shows that the path length for each turn is approximately l=30 mm. Dimension l, as shown in FIG. 1a, excludes the portion of the tabs that would normally be inserted into printed circuit board vias under the assumption that heat generated by interconnection resistance will be dissipated primarily by features external to the transformer, such as a printed circuit board. The resistance of the N primary staples in series can then be calculated from Eq. 14 to be

Rₚᵣᵢ=3·1.724·10⁻⁵·30/(3.8·0.5)=8.16·10⁻⁴=0.816 mΩ.

Similarly, resistance of the N main secondary tabs in parallel can also be calculated by Eq. 14 to be

R_{sec}=1.724·10⁻⁵·30/(6.9·0.5)/3=5.00·10⁻⁵=50.0 μΩ.

These values must be corrected at +0.393% per ° C. to accommodate the maximum allowable operating temperature Tₘₐₓ=105° C., yielding Rₚᵣᵢ=1.09 mΩ and R_{sec}=66.7 μΩ. Using basic transformer theory the primary current is given by

Iₚᵣᵢ=I_{sec}/N=27.5/3=9.17 A_{RMS}.

With these values the Effective Series Resistance is calculated from Eq. 13 to be

ESR=(1.09·10⁻³+3²·66.7·10⁻⁶)=1.69·10⁻³ Ω=1.69 mΩ,

resulting in a copper loss given by Eq. 12 to be

P_{Cu}≈1.69·10⁻³·9.17²=0.142=142 mW.

With the P_{Cu} target value suggested to be 20% of the copper loss allocation, which in turn was chosen to be 65% of the total power dissipation limit P_{D(Limit)}, the explicit target value for P_{Cu} then becomes 0.20·0.65·1696=220 mW. In this case, the copper loss estimate P_{Cu} was significantly lower than the suggested target value, indicating that the winding thickness dimension t could have been reduced somewhat, yet still yielded an acceptable loss. However, reducing the winding thickness can eventually compromise the mechanical integrity of the structure.

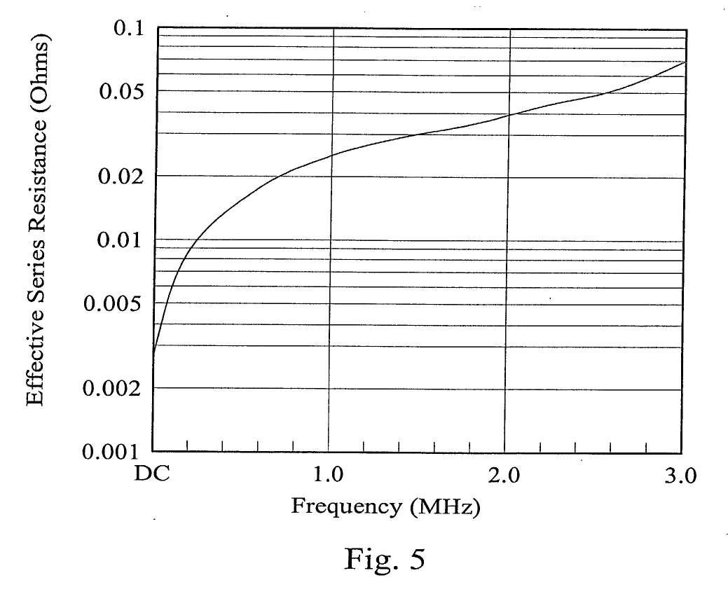

The actual core loss for a prototype of the transformer shown in FIG. 1 measured 606 mW, in close agreement with the predicted value. The reactive component of leakage impedance (i.e., leakage inductance) measured 120 nH, and was substantially independent of frequency from 200 KHz to 3 MHz. As expected, the ESR was very frequency dependent and is recorded in FIG. 5.

Data points from FIG. 5 can be used to estimate the true Ohmic losses present in the windings under full-load conditions. In circuit, the application of the prescribed square wave voltage results in a substantially square wave current, bandwidth-limited to approximately 3 MHz by the leakage inductance. The square wave current has an amplitude of 9.17 Amps, and can be broken down into its harmonic components as shown in Table 2.

TABLE 2

| Harmonic | Harmonic | Re(Z_{leakage}) | Copper |
|---|---|---|---|
| Frequency | Current | (ESR) | Loss |
| (MHz) | (Amps) | (W) | (mW) |
| 0.200 | 8.36 | 0.0095 | 664 |
| 0.600 | 2.79 | 0.0176 | 137 |
| 1.000 | 1.67 | 0.024 | 67 |
| 1.400 | 1.19 | 0.030 | 42 |
| 1.800 | 0.93 | 0.035 | 30 |
| 2.200 | 0.76 | 0.05 | 29 |
| 2.600 | 0.64 | 0.05 | 20 |
| 3.000 | 0.56 | 0.07 | 22 |

| | |
|---|---|
| Total Copper Loss (mW) | 1011 |

The sum of the Ohmic losses, each of which is calculated at its respective harmonic frequency, yields the actual copper loss. The total power dissipation, then, is given by

P_{D}=P_{Fe}+P_{Cu}=606+1011=1617 mW.

This satisfies the initial design condition P_{D}≦P_{D(Limit)}, indicating a viable design.

The single-turn main secondary structure is easy to fabricate and install compared to other commonly employed methods, such as multiple paralleled conventional windings and multilayer planar structures. The single-turn structure provides a relatively thin conductor depth while providing a large cross-sectional area. In particular, the large cross-sectional area minimizes the resistance of the conductor required to carry the largest current, and the elongated conducting path minimizes skin effects that would increase the effective a.c. resistance of the winding at the switching frequency and its harmonics. The single-turn construction avoids the proximity effects that often accompany transformers constructed using multilayer windings, which also increase the effective a.c. resistance.

The combination of a large main secondary cross-sectional area and a thin conductor depth will by necessity have a large surface area. From the perspective of thermal management, this can be exploited. For example, the large surface area can be used for convective cooling in a manner similar to that of fins on a heatsink. The terminations can also be shaped to provide significant additional cooling by conducting winding heat into wide traces on the printed circuit board onto which the transformer is mounted.

The single-turn main secondary structure can be exploited for its magnetic and electrostatic shielding characteristics, especially when the main secondary fully encloses both the core and the primary, and when the outermost tabs of the main secondary are grounded.

The leakage impedance (the generally undesirable parasitic element which is the vector sum of leakage inductance reactance and a.c. resistance) will be small in magnitude, and will vary from unit to unit only to the extent that the mechanical dimensions and positioning of the components are allowed to vary.

The aspect ratio of the transformer (the ratio of height to footprint) can be readily adapted to fit a wide range of dimensional constraints. Commonly, the dimensional constraints are low profile (low height-to-footprint ratio), typically dictated by enclosure height or spacing between printed circuit board cards, and minimum footprint, where height is not a constraining factor but printed circuit board real estate is.

The invention has been described with respect to exemplary embodiments. In light of this disclosure, those skilled in the art will likely make alternate embodiments of this invention. These and other alternate embodiments are intended to fall within the scope of the claims which follow.

What is claimed is:

1. A transformer, comprising:
a magnetic core having a substantially toroidal shape;
a plurality of conductors distributed around the magnetic core, each conductor partially enclosing a portion of the core and being adapted to be electrically connected to form a first winding; and
a single sheet of metallic material formed to partially enclose portions of the core, edges of the sheet being adapted to be electrically connected to form a second winding.

2. The transformer of claim 1, wherein the formed sheet provides substantially uniform distribution of current around the core annulus.

3. The transformer of claim 2, wherein the sheet is electrically equivalent to a single turn.

4. A transformer, comprising:
a magnetic core having a substantially toroidal shape;
a plurality of conductors distributed around the magnetic core, each conductor partially enclosing a portion of the core and being adapted to be electrically connected to form a first winding; and
a single sheet of metallic material formed to substantially enclose the core and the first winding, edges of the sheet being adapted to be electrically connected to form a second winding.

5. The transformer of claim 4, wherein the formed sheet provides substantially uniform distribution of current around the core annulus.

6. The transformer of claim 5, wherein the sheet is electrically equivalent to a single turn.

7. A transformer, comprising:
a magnetic core having a substantially toroidal shape;
at least one winding applied to the core, each of the at least one winding enclosing at least a portion of the core annulus, thereby forming a wound core; and
a single sheet of metallic material formed to substantially enclose the wound core.

8. The transformer of claim 7, wherein the formed sheet forms an additional winding.

9. The transformer of claim 8, wherein the additional winding provides substantially uniform distribution of current around the core annulus.

10. The transformer of claim 9, wherein the additional winding is electrically equivalent to a single turn.

11. A printed circuit assembly comprising:
a printed circuit board having a plurality of conductive traces;
a transformer electrically connected to the printed circuit board, the transformer having a magnetic core and a plurality of conductors, each conductor partially enclosing a portion of the core and being adapted to be electrically connected;
wherein at least some of the plurality of conductors are electrically connected in series to at least some of the conductive traces are to form a first winding; and
wherein at least some of the plurality of conductors are electrically connected in series to at least some of the conductive traces are to form a second winding, the second winding being separate from the first winding.
